(19) United States
(12) Patent Application Publication
(10) Pub. No.: US 2015/0225560 A1
(43) Pub. Date: Aug. 13, 2015

(54) EPDM RUBBER COMPOSITION FOR A MUFFLER HANGER WITH HIGH THERMAL RESISTANCE AND LOW DYNAMIC RATIO

(71) Applicants: HYUNDAI MOTOR COMPANY, Seoul (KR); KIA MOTORS CORPORATION, Seoul (KR)

(72) Inventor: Ho Dong Kim, Jecheon (KR)

(73) Assignees: KIA MOTORS CORPORATION; HYUNDAI MOTOR COMPANY

(21) Appl. No.: 14/565,258

(22) Filed: Dec. 9, 2014

(30) Foreign Application Priority Data
Feb. 13, 2014 (KR) 10-2014-0016680

(51) Int. Cl. C08L 23/16

(52) U.S. Cl. CPC C08L 23/16; C08L 2201/08; C08L 2205/025; C08L 2205/03

(57) ABSTRACT

Provided is an ethylene propylene diene monomer (EPDM) rubber composition for a muffler hanger with high thermal resistance and low dynamic ratio, thereby improving mechanical properties. The EPDM rubber composition of the present invention is prepared by blending two heterogeneous EPDMs having different EPDM rubber composition.

### CROSS-REFERENCE TO RELATED APPLICATION

This application claims under 35 U.S.C. §119(a) the benefit of Korean Patent Application No. 10-2014-0016680 filed on Feb. 13, 2014, the entire contents of which are incorporated herein by reference.

### TECHNICAL FIELD

The present invention relates to an ethylene propylene diene monomer (EPDM) rubber composition for a muffler hanger with high thermal resistance and low dynamic ratio. Particularly, the EPDM rubber composition for a muffler hanger with high thermal resistance, low dynamic ratio may have various improved properties or improved mechanical properties obtained by blending two types of EPDMs which may have heterogeneous properties.

### BACKGROUND

A muffler hanger component of a vehicle may provide improved driver comfort by reducing vibration and noise generated in the underbody of the vehicle.

However, as the customers' needs for high power vehicles increase, demands for gasoline direct injection (GDI) and turbo engine vehicles have been gradually increasing, and such vehicle engines may cause elevating an ambient temperature in peripheral parts of an exhaust system. The elevated temperature of the exhaust system may accelerate the curing of a muffler hanger rubber unit and further cause the deflection of a rubber hanger by the muffler weight after long-term use. In addition, vibration/noise insulating function of the rubber may deteriorate.

Accordingly, development of an EPDM muffler hanger which may insulate the vibration/noise of a vehicle underbody for a long period of time, minimize the muffler hanger deformation caused by rubber aging and prevent the occurrence of cracks in advance has been desired.

In the related technologies in the art, an EPDM material-based muffler hanger has been developed and the muffler hanger is formed with EPDM rubber molded in a muffler hanger design form and a heat reflection coating layer covered on the surface of the EPDM to reflect the heat. The heat reflection coating layer has Acrylic Ethylene (AEM) rubber as a coating substrate, and an aluminum flake is mixed thereto for heat reflection. However, in this case, the physical properties of the rubber composition itself may not be improved, and instead, heat reflection may be induced by forming a specific coating layer on the surface of the rubber composition. Accordingly, a separate process may be required for forming the coating layer, and thus causes the increase of manufacturing costs and requires care in the coating process.

In addition, a vibration proof rubber composition including EPM and EAM as a rubber substance has been developed. The content ratio of the EPM and the EAM is EPM/EAM having a weight ratio of about 95/5 to 5/95 and the ethylene/propylene weight ratio of the EPM is of about 40:60 to 90:10. The composition may be a thermal-resistant vibration proof rubber composition used under elevated temperature environments such as a torsional damper, an engine mount and a muffler hanger.

Further, in another example of the related art, provided is a vibration proof rubber composition in which an ethylene propylene-based polymer (EPDM) is a main substance, natural rubber and carbon black are mixed thereto, and peroxide is added thereto as a cross-linking agent, thereby having excellent thermal resistance, and the natural rubber is mixed in less than 50 parts by weight with respect to 50 parts by weight of the ethylene propylene-based polymer when the total amount of the polymer is 100 parts by weight, and the vibration proof rubber composition is used for an engine mount, a muffler hanger, a damper and the like. Also disclosed is a highly durable vibration proof rubber composition for vehicles using a hybrid crosslinking system, which includes carbon black in 25 to 60 parts by weight, a sulfur cross-linking agent in 0.1 to 2 parts by weight, a peroxide cross-linking agent in 1 to 10 parts by weight, an activator in 0.1 to 2 parts by weight, an accelerator 1 to 5 parts by weight and a vulcanizing coagent 1 to 3 parts by weight with respect to 100 parts by weight of EPDM rubber.

In the related art, those EPDM rubber compositions may be effective in improving partial physical properties including thermal resistance; however, overall physical properties need to be improved. Moreover, these EPDM rubber compositions may be manufactured optimally for general thermal resisting conditions of typical engine exhaust systems, but may not be used in a muffler hanger of turbo/GDI engines and the like in which the temperature of exhaust system may be elevated by about 10° C.

In a certain related document, an EPDM rubber composition relating to a polymer mixture for EPDM alternatives including high molecular weight EPDM rubber, conjugated diene rubber and low molecular weight EPDM rubber has been developed. In the high molecular weight EPDM rubber, the content of ethylene ranges from approximately 58% by weight to approximately 68% by weight, and the content of diene ranges from approximately 8.0% by weight to approximately 11.5% by weight with reference to the EPDM, and the content of oil ranges from approximately 45% by weight to approximately 55% by weight with respect to the total weight of the high molecular weight. In the low molecular weight EPDM rubber, the content of ethylene ranges from approximately 75% by weight to approximately 85% by weight, and the content of diene ranges from approximately 5% by weight to approximately 10% by weight.

Although the above developments provide improvements in rubber compositions having improved physical properties by using mixing technologies of EPDM substances, early vibration insulating performance and driving territories may be inferior and improving physical properties such as thermal resisting conditions has been limited.

The description provided above as a related art of the present invention is just merely for helping understanding of the background of the present invention and should not be construed as being included in the related art known by those skilled in the art.

### SUMMARY OF THE INVENTION

We now disclose the present invention to provide technical solutions to the above-described technical difficulties associated with related art. Accordingly, the present invention provides a novel EPDM rubber composition for a muffler hanger with high thermal resistance, low dynamic ratio and various improved physical properties. The EPDM rubber composition may be prepared by blending two types of EPDMs, which may contain heterogeneous ethylene contents and oil contents and further adding additives to the EPDM composition of the invention.

In one aspect, the present invention provides an EPDM rubber composition for a muffler hanger with high thermal resistance, low dynamic ratio, and various improved physical properties by blending two types of heterogeneous EPDMs having different physical properties.

In another aspect, the present invention also provides an EPDM rubber composition for a muffler hanger having substantially improved physical properties even when applied to turbo engine and GDI engine mufflers of vehicles. In particular, the EPDM rubber composition of the invention may be substantially effective in insulating underbody noise of the vehicles and minimizing deflection after driving for a long period of time due to delay in rubber aging.

In an exemplary embodiment, the present invention provides the EPDM rubber composition for a muffler hanger with substantially high thermal resistance and low dynamic ratio which may include a blended mixture of: a first EPDM including ethylene in an amount of about 68 to 75% by weight, diene in an amount of about 3 to 10% by weight and oil in an amount of about 40 to 60% by weight based on the total weight of the first EPDM; and a second EPDM including ethylene in an amount of about 55 to 62% by weight, diene in an amount of about 3 to 10% by weight and not containing oil based on the total weight of the second EPDM. In particular, a weight ratio of the first EPDM and the second EPDM may be in a range of about 7:3 to 9:1.

According to various exemplary embodiments of the present invention, a rubber material obtained from the blended mixture may have improved vibration insulating performance and thermal resisting performance, thereby providing the rubber composition which may be substantially effective for a muffler hanger of a vehicle.

Particularly, the rubber composition in the present invention may be substantially effective in insulating underbody noise of vehicles during driving of a vehicle and minimizing deflection after driving for a substantially long period of time by delaying the rubber aging when applied to an automotive muffler hanger.

In addition, when the rubber composition according to the present invention is used for a hanger for muffler, indexes in the vehicle vibration noise area may be improved due to improved physical properties such as high thermal resistance and low dynamic ratio, and the deformation of a muffler hanger may be minimized and the crack occurrences may be prevented in advance. Accordingly, the EPDM rubber composition in the exemplary embodiments of the present invention may also significantly reduce customers' claims which may be caused by quality deterioration such as noise and the like.

### BRIEF DESCRIPTION OF THE DRAWINGS

The above and other features of the present invention will now be described in detail with reference to certain exemplary embodiments thereof illustrated by the accompanying drawing which is given hereinbelow by way of illustration only, and thus are not limitative of the present invention, and wherein:

FIGS. 1A-1B show noise measurement results of Test Example 2 in a floor vibration state (FIG. 1A) and in a seat booming state (FIG. 1B) performed after an exemplary muffler hanger product prepared from an exemplary composition of Example 3 according to an exemplary embodiment of the present invention. In comparison, commercialized products are applied to a vehicle.

It should be understood that the appended drawing is not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

As used herein, “EPDM” refers to a rubber containing ethylene, propylene and diene components. EPDM may include a certain range of ethylene, a certain range of prolylene and a certain range of diene, but the range of each component may not be limited. In certain exemplary embodiments, the EPDM rubber may contain an oil content in a predetermined range while the EDPM substance is contained as main components.

As used herein, “Mooney viscosity” refers to a measure of viscosity commonly used for rubbers taken at a certain temperature. In certain exemplary embodiments, the Mooney viscosity may be measured at a temperature of about 100° C.

As used herein, “pure EPDM rubber substance” refers to a rubber resin in each EPDM rubber excluding the oil content. Further, “pure EPDM rubber substance in the mixture” refers to a combined EPDM rubber composition in the mixture, for example, a blended mixture of the first EPDM and the second EPDM, excluding the oil content. In certain exemplary embodiments of the present invention, the weight parts of the additives in the rubber composition is based on the total weight of the pure EPDM rubber substance in the mixture set as 100 parts.

[Please Confirm Above Descriptions are Proper in View of the Invention.]

Hereinafter, reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

The present invention provides an EPDM rubber composition for a muffler hanger having an EPDM as a main substance. In an exemplary embodiment, improved physical properties may be obtained by the EPDM rubber composition which may be obtained by blending: a first EPDM including ethylene in an amount of about 68 to 75% by weight, diene in an amount of about 3 to 10% by weight and oil in an amount of about 40 to 60% by weight, based on the total weight of the first EPDM; and a second EPDM including ethylene in an amount of about 55 to 62% by weight, diene in an amount of about 3 to 10% by weight and not containing oil (non-oil), based on the total weight of the second EPDM.

In certain exemplary embodiments, in the EPDM rubber composition, the first EPDM containing oil and the second EPDM not containing oil may be blended in a weight ratio of about 7:3 to 9:1. In particular, the weight ratio thereof may be about 8:2.

According to certain exemplary embodiments, when each ethylene content in the first and the second EPDMs is less than the predetermined range as described above, cracks may readily occur since mechanical properties and fatigue strength may be reduced when used for a muffler hanger, and vibration insulating performance during driving may be degraded. In addition, when the ethylene content is greater than the predetermined range described above, production capability may be reduced since mass productivity may be reduced due to low flowability, and vibration may be substantially generated in the cold weather condition and the like when such composition is used for a muffler hanger due to the reduced low temperature resistance.

When the mixture of the first and the second EPDMs are used, the EPDM may be a 3-membered copolymer of ethylene, propylene and diene (ENB) which may be formed in cross-linking. Among components of the EPDM, a double bond included in the diene (ENB) may be broken when mixed with rubber and may form sulfur cross-linking. In such EPDM, increase of Mooney viscosity may improve mechanical properties and rebound resilience; however, roll workability may be reduced, which may further lead to decrease in practical flowability during parts production, thereby causing molding scorch. Moreover, processibility may also be reduced due to the cross-linking at the nozzle thereby deteriorating the produced parts.

Accordingly, in one aspect of the present invention, mechanical properties and rebound resilience or improved dynamic ratio may be improved by using an EPDM with high Mooney viscosity, and simultaneously, using EPDM with high Mooney viscosity as a mixture by blending an oil-included EPDM and a non-oil EPDM under an optimized condition. Conventional EPDMs in the related art may be inferior since these EPDMs have Mooney viscosity of approximately 45 and a single type EPDM not containing oil (non-oil) has been used in 100 parts by weight, thereby resulting in substantially low rebound resilience.

According to certain exemplary embodiments, mechanical properties and rebound resilience may be maximized by using the mixture of the first and the second EPDMs of which physical properties are different and the presence of oil is different from each other. As a consequence, the EPDM rubber composition may have improved Mooney viscosity (ML₁₊₄) to about 55 or greater at a temperature of about 100° C., or particularly have the Mooney viscosity of about 55 to 65 in an EPDM specification.

In addition, oil may be included to improve rubber molding. When the non-oil second EPDM is used alone, roll workability may be reduced due to the high Mooney viscosity. Accordingly, when the first EPDM including substantial content of ethylene is blended to the non-oil EPDM simultaneously to use as a mixture, an optimized mixture composition may be obtained.

The EPDM blended with the first and the second EPDMs may be prepared to have the Mooney viscosity (ML₁₊₄) of about 55 to 65 at a temperature of about 100° C. Furthermore, polymers with a substantially narrow molecular weight distribution may be used for the EPDM composition, and thus, vibration insulating performance and mechanical properties may be further improved.

In addition, when the first EPDM is included in the EPDM composition in an amount less than the predetermined weight ratio as described above, the effects of vibration and insulating property improvement may not be obtained sufficiently. When the first EPDM is included in the EPDM composition in an amount greater than the predetermined weight ratio as described above, blending may not be performed sufficiently due to high Mooney viscosity.

According to various exemplary embodiments of the present invention, when an automotive muffler hanger using an EPDM rubber composition formed by adding common additives to the rubber substance blended with the first and the second EPDMs described above is prepared and applied, high thermal resistance and low dynamic ratio are obtained since more superior physical properties are exhibited as compared to existing materials.

In an exemplary embodiment, a EPDM rubber composition may include a blended mixture of: a first EPDM including ethylene in an amount of about 68 to 75% by weight, diene in an amount of about 3 to 10% by weight and oil in an amount of about 40 to 60% by weight, based on the total weight of the first EPDM; and a second EPDM including ethylene in an amount of about 55 to 62% by weight, diene in an amount of about 3 to 10% by weight and not containing oil (non-oil), based on the total weight of the second EPDM. The weight ratio between the first EPDM and the second EPDM may be in a range of about 7:3 to 9:1.

The EPDM rubber composition may further include: carbon black in an amount of about 40 to 60 parts by weight. In certain exemplary embodiments, the EPDM rubber may further include carbon black in a form of a mixture of Fast Extruding Furnace (FEF) and Medium Thermal (MT) in an amount of about 40 to 60 parts by weight, and a sulfur cross-linking agent 0.1 to 2.0 parts by weight, with respect to 100 parts by weight of the pure EPDM rubber substance in the mixture. As described above, the pure EPDM rubber substance in the mixture refers to a combined EPDM rubber composition in the mixture, for example blended mixture of the first EPDM and the second EPDM, excluding the oil content. It would be understood that the weight parts of the additives in the rubber composition is based on the total weight of the pure EPDM rubber substance in the mixture set as 100 parts, otherwise indicated.

In another exemplary embodiment, the EPDM rubber composition may further include one or more vulcanizing accelerators in an amount of about 1 to 10 parts by weight, with respect to 100 parts by weight of the pure EPDM rubber substance in the mixture and the vulcanizing accelerators may be selected from sulfonamide-based slow-release accelerators and thiuram-based ultra-accelerators. In addition, the EPDM rubber composition for a muffler hanger with high thermal resistance and low dynamic ratio may further include an aging prevention agent in an amount of about 1 to 10 parts by weight with respect to 100 parts by weight of the pure EPDM rubber substance in the mixture and the aging prevention agent may be include one or more selected from phenyl-based and quinoline-based compounds, and paraffin-based wax. [FROM MANUFACTURER'S DESCRIPTION, SUNOC MAY BE A PARAFFIN-BASED RUBBER PROTECTIVE WAX. PLEASE CONFIRM THIS WITH INVENTORS.] When the carbon black is a mixed form of FEF and MT and used in an exemplary embodiment, physical properties may be substantially improved compared to compositions including a single carbon black material in the related art. For example, in the related art, muffler hangers may generally have improved mechanical properties by using commonly used carbon black such as FEF, which is a N550 series according to classification method of American Society of Testing Materials and has a diameter of about 42 nm, as a filler, however, in this case, vibration insulating performance may be reduced. In contrast, in certain exemplary embodiments of the present invention, FEF and MT may be blended as a filler and stiffener most preferably and using them as a filler (stiffener), rebound resilience (vibration insulating performance) may be substantially improved compared to the single carbon black composition in the related art and mechanical properties may be improved. The MT, as used herein, may have a diameter of about 200 nm or greater as an N990 series according to classification of American Society of Testing Materials. In particular, MT having a diameter of about 200 to 300 nm may be used in the EPDM rubber composition of the invention. In addition, the weight ratio of the FEF and the MT may be in a range of about 3:1 to 3:3, or particularly of about 3:2.

In certain exemplary embodiments, the EPDM rubber composition may further include across-linking agent and the cross-linking agent may be a sulfur cross-linking agent in an amount of about 0.1 to 2 parts by weight, or particularly in an amount of about 0.5 to 1 parts by weight, with respect to 100 parts by weight of the pure EPDM rubber substance in the mixture. When the content of the sulfur cross-linking agent is less than a predetermined amount, for example, less that about 0.5 part by weight, heat resistance may be satisfactory but vibration and noise insulating performance may be degraded due to the decline of rebound resilience.

Furthermore, the EPDM rubber composition may further include a peroxide which may be used as a cross-linking agent in an amount of about 1 to 10 parts by weight in addition to the sulfur cross-linking agent. When the content of the peroxide is less than about 1 parts by weight, improvement in thermal resistance may not be sufficinetly obtained since the cross-linking density may be reduced. When the peroxide is used in an amount greater than about 10 parts by weight, the peroxide may break the main chain of the EPDM rubber, and the physical properties of the rubber composition may deteriorate. Accordingly, peroxide may be used together with a sulfur cross-linking agent as a cross-linking agent, thereby obtaining substantially improved thermal resistance and dynamic properties by the flexibility of the sulfur chain and the strengthened bonding of the peroxide with the main chain. In contrast, when a single cross-linking system is used, thermal resistance and dynamic properties may not be improved.

In addition, in various exemplary embodiments, a vulcanizing accelerator, an aging prevention agent, an activator, a vulcanizing coagent and the like may be included in the EPDM rubber composition. The vulcanizing accelerator may be included in the rubber composition. In addition, the vulcanizing accelerator may include a sulfonamide-based slow-release accelerator and a thiuram-based ultra-accelerator and may be used in an amount of about 1 to 10 parts by weight, with respect to 100 parts by weight of the pure EPDM rubber substance in the mixture.

In particular, the vulcanizing accelerator may be mixed an amount of about 0.5 to 1.5 parts by weight of the slow-release accelerator and an amount of about 1 to 2 parts by weight of the ultra-accelerator. In this vulcanizing accelerator, as used herein, the ultra-accelerator may reduce the manufacturing costs in manufacturing by increasing cross-linking rates, and the slow-release accelerator may improve the quality by preventing the scorch during molding and adjusting cross-linking density. Accordingly, the vulcanizing accelerator may be used in the rubber composition by mixing the ultra-accelerator and the slow-release accelerator. Particularly, tetramethylthiuram disulfide (TT) may be used as the ultra-accelerator, and N-cyclohexylbenzothiazole-2-sulfenamide (CZ) may be used as the slow-release accelerator. When the vulcanizing accelerator is included less than the predetermined amount, for example, less than about 1 part by weight, the quality of the molded product may be degraded due to the occurrence of scorch during the molding and the time for production may increase. When the vulcanizing accelerator is included greater than the predetermined amount, for example, greater than about 1 part by weight, moldability may be degraded due to short processing time.

In certain exemplary embodiments, the EPDM rubber composition may further include the aging prevention agent. The aging prevention agent may be one or more selected from phenyl-based and quinoline-based compounds, and Sunoc and may be used in an amount of about 1 to 10 parts by weight, with respect to 100 parts by weight of the pure EPDM rubber substance in the mixture. In particular, the aging prevention agent may include N-phenyl-N′-isopropyl-P-pthenylenediamine (3C) as a phenyl-based compound, 1,2-dihydro-2,2,4-trimethyl quinoline (RD) as a quinoline-based compound, and Sunoc as an antifouling agent.

The aging prevention agent, as used herein, may prevent early rubber aging caused by the high temperature of the exhaust system surroundings, and reduce the generation of vibration/noise at the underbody of vehicles by maintaining rubber elasticity even after driving for a long period of time. When the aging prevention agent is included greater than the predetermined amount, for example, greater than about 10 parts by weight, initial rubber properties may be degraded, and blooming, a boil form of the rubber may be generated in the surroundings of the rubber after molding.

In certain exemplary embodiments, the EPDM rubber composition may further include the activator. The activator may be one or more selected from generally used zinc oxide (ZnO) and polyethylene glycol, and may be used in an amount of about 1 to 10 parts by weight with respect to 100 parts by weight of the pure EPDM rubber substance in the mixture. When the activator is included greater than the predetermined amount, for example, greater than about 10 parts by weight, processibility may deteriorate. In particular examples, zinc oxide in an amount of about 3 to 7 parts by weight may be included in the rubber composition.

Moreover, the EPDM rubber composition may further include the vulcanizing coagent. The vulcanizing coagent may be a stearic acid, and the content thereof may be in an amount of about 1 to 3 parts by weight, with respect to 100 parts by weight of the pure EPDM rubber substance in the mixture. When the content of the vulcanizing coagent is less than the predetermined amount, for example, less than about 1 part by weight, rate of the cross-linking reaction may be reduced. When the content of the vulcanizing coagent is greater than the predetermined amount, for example, greater than about 3 parts by weight, rate of the cross-linking reaction may increase substantially causing a problem in productivity.

As described above, the EPDM rubber composition for a muffler hanger according to various exemplary embodiments of the present invention may improve the quality of a muffler hanger by enhancing rubber mixability as the oil containing first EPDM and the non-oil second EPDM are blended. Particularly, by having high thermal resistance and low dynamic ratio, the rubber composition may minimize rubber unit deflection even after a fatigue endurance test, and may improve vibration insulating performance and mechanical properties due to thermal aging. Furthermore, the compression set may be improved by maintaining the ENB content in an amount of about 5% by weight and having Mooney viscosity (ML₁₊₄) at about 55 or greater at a temperature of about 100° C., thereby improving the flexibility of rubber materials when molded as a muffler hanger.

Accordingly, the present invention includes a muffler hanger of a vehicle manufactured by using the EPDM rubber composition as described above.

### EXAMPLES

The following examples illustrate the invention and are not intended to limit the scope of the invention.

### Examples 1 to 4 and Comparative Examples 1 to 2

Each EPDM rubber composition for a muffler hanger was prepared using the substances listed in Table 1 and according to the composition described in Table 2.

Herein, the first EPDM including ethylene in an amount of about 70% by weight, diene in an amount of about 5% by weight and oil in an amount of about 50% by weight was used. The second EPDM including ethylene in an amount of about 60% by weight, diene in an amount of about 5% by weight and not containing oil was used.

In Examples 1 to 4, each composition was prepared by blending the first and the second EPDMs in a weight ratio of about 8:2. In Comparative Example 1, only the first EPDM (1 type) was used as a raw material substance. In Comparative Example 2, the composition was prepared using the first and the second EPDMs in a weight ratio of about 6:4.

As shown in Table 2, when the first EPDM includes oil in an amount of about 50% by weight, and the content of the pure rubber substance in the first EPDM corresponds to 50% by weight of the total. Consequently, in Examples 1 to 4 and Comparative Examples 1 to 2, the sum of the total EPDM rubber content in the first and the second EPDMs was used as 100 parts by weight at all times.

In Table 1, each content of the additive other than the first and the second EPDMs is shown by parts by weight, and the weight parts of the additives in the rubber composition of Table 2 is based on the total weight of the pure EPDM rubber substance in the mixture including the first EPDM and the second EPDM, which is set as 100 parts (phr: parts per hundred rubber).

TABLE 1

| Used Substances | | Specific Substances (Manufacturer) |
|---|---|---|
| Raw Material | EPDM | Ethylene Propylene Diene Monomer |
| Rubber | | |
| Sulfur | S | (Miwon Commercial Co. Ltd.) |
| Cross-linking | | |
| Agent | | |
| Peroxide | DCP | Dicumyl Peroxide (Pyunghwa Chemical) |
| Vulcanizing | CZ | Cyclohexylbenzothiazole sulfenamide |
| Accelerator | | (Dongyang Chemical) |
| | TT | Tetramethylthiuram disulfide |
| | | (Dongyang Chemical) |
| Filler | FEF, MT | (Korea Carbon Black) |
| (Stiffener) | | |
| Activator | ZnO | Zinc Oxide (Hanil Zinc Oxide Industry) |
| | Stearic | Stearic Acid (Dansuk Industrial Co. Ltd.) |
| | acid | |
| Aging | 3C | N-Phenyl-N′-Isopropyl-P-Phenylenediamine |
| Prevention | | (Kumho Monsanto, Inc.) |
| Agent | | |
| | RD | 1,2-dihydro-2,2,4-trimethyl quinoline |
| | | (Bayer) |
| | Sunoc | Sunoc-DW Antiozonant (Daewoon Co. Ltd.) |

TABLE 2

| | Mixed Amounts | | | | | | |
|---|---|---|---|---|---|---|---|
| Mixed | Example | Example | Example | Example | Comparative | Comparative | Composition |
| Substances | 1 | 2 | 3 | 4 | Example 1 | Example 2 | Substances |
| First | 160 | 160 | 160 | 160 | 200 | 120 | Raw |
| EPDM | (EPDM | (EPDM | (EPDM | (EPDM | (EPDM | (EPDM | Material |
| (Contain | 80 + Oil | 80 + Oil | 80 + Oil | 80 + Oil | 100 + Oil | 60 + Oil | Rubber |
| 50% of | 80) | 80) | 80) | 80) | 100) | 60) | |
| Oil) | | | | | | | |
| Second | 20 | 20 | 20 | 20 | — | 40 | |
| EPDM | | | | | | | |
| pure | 100 | 100 | 100 | 100 | 100 | 100 | |
| rubber | | | | | | | |
| substance | | | | | | | |
| (parts by | | | | | | | |
| weight) | | | | | | | |
| ZnO | 5 | 5 | 5 | 5 | 5 | 5 | Activator |
| (parts by | | | | | | | |
| weight) | | | | | | | |
| ST/A | 1.5 | 1.5 | 1.5 | 1.5 | 1.5 | 1.5 | Vulcanizing |
| (parts by | | | | | | | Coagent |
| weight) | | | | | | | |
| SC | 1.5 | 1.5 | 1.5 | 1.5 | 1.5 | 1.5 | Aging |
| (parts by | | | | | | | Prevention |
| weight) | | | | | | | Agent |
| RD | 1 | 1 | 1 | 1 | 1 | 1 | |
| (parts by | | | | | | | |
| weight) | | | | | | | |
| SUNOC- | 1.5 | 1.5 | 1.5 | 1.5 | 1.5 | 1.5 | |
| DW | | | | | | | |
| (parts by | | | | | | | |
| weight) | | | | | | | |
| FEF | 30 | 30 | 30 | 30 | 30 | 30 | Filler |
| (parts by | | | | | | | (Stiffener) |
| weight) | | | | | | | |
| MT | 20 | 20 | 20 | 20 | 20 | 20 | |
| (parts by | | | | | | | |
| weight) | | | | | | | |
| S | 0.4 | 0.5 | 0.8 | 0.5 | 0.8 | 0.8 | Sulfur |
| (parts by | | | | | | | Cross-linking |
| weight) | | | | | | | Agent |
| DCP | — | — | — | 5 | — | — | Peroxide |
| (parts by | | | | | | | |
| weight) | | | | | | | |
| CZ | 0.8 | 0.8 | 0.8 | 0.7 | 0.8 | 0.8 | Vulcanizing |
| (parts by | | | | | | | Accelerator |
| weight) | | | | | | | |
| TT | 1.5 | 1.5 | 1.5 | 2.5 | 1.5 | 1.5 | |
| (parts by | | | | | | | |
| weight) | | | | | | | |

### TEST EXAMPLES

### Test Example 1

A center muffler hanger of a vehicle UM (SUV vehicle developed by Hyundai Motor Company) was prepared using the EPDM rubber composition in the Examples 1-4 and the Comparative Examples 1-2, and mechanical properties and thermal resistance thereof were measured. The results are shown in Table 3.

Herein, physical property measurement tests were performed and measured using the test methods below.
Hardness was measured with JIS K 6301 Type 3, such that about 4 to 5 specimens were stacked and then Shore A unit hardness was measured.
Tensile strength was measured by JIS K 6301 Type 3, such that tension speed was about 500 mm/min.
Elongation was measured by JIS K 6301 Type 3, such that tension speed was 500 mm/min.
Material dynamic ratio was an average value obtained by repeatedly vibrating static/dynamic spring constants for about 5 to 6 times at a fixed frequency of about 15 Hz using dynamic mechanical analysis (DMA). (Tension: 10%, Vibration: 1%)
Hardness change was measured after material specimens were thermally aged.
Tensile strength change rate was measured after material specimens were thermally aged.
Elongation change rate was measured after material specimens were thermally aged.

TABLE 3

| | | | Muffler Hanger Preparation Sample | | | | | |
|---|---|---|---|---|---|---|---|---|
| | | | | | | | Comparative | Comparative |
| | | | Example | Example | Example | Example | Example | Example |
| Item | | | 1 | 2 | 3 | 4 | 1 | 2 |
| Physical | Hardness (Hs) | | 43 | 43 | 44 | 44 | 44 | 44 |
| Properties | Mechanical | Tensile | 182 | 175 | 150 | 162 | 165 | 139 |
| | Properties | Strength | | | | | | |
| | | (Kgf/cm²) | | | | | | |
| | | Elongation | 790 | 720 | 650 | 710 | 730 | 660 |
| | | (%) | | | | | | |
| | | Material | 1.47 | 1.39 | 1.34 | 1.43 | 1.52 | 1.53 |
| | | dynamic | | | | | | |
| | | ratio | | | | | | |
| | | (@25 Hz) | | | | | | |
| | Thermal | Hardness | +1 | +2 | +2 | 0 | +4 | +2 |
| | Resistance | changes | | | | | | |
| | (120° C. × | (Δ Hs) | | | | | | |
| | 1000 Hr) | Tensile | −57 | −57 | −52 | −56 | −60 | −51 |
| | | strength | | | | | | |
| | | change | | | | | | |
| | | rate | | | | | | |
| | | (%) | | | | | | |
| | | Elongation | −37 | −42 | −44 | −43 | −43 | −45 |
| | | change | | | | | | |
| | | rate | | | | | | |
| | | (%) | | | | | | |

As seen from the test results above, in Examples 1 to 4, the dynamic ratio was less than the dynamic ratio in the comparative examples. Particularly in Comparative Example 1 of a conventional composition, the dynamic ratio was substantially greater than that of Examples 1 to 4 of the present invention, and hardness changes and tensile strength changes were greater than those of Examples 1 to 4. In addition, in Comparative Example 2, when the mixed ratio of the first and the second EPDMs is beyond the range of the present invention, tensile strength, dynamic ratio and the like may not be obtained sufficiently as compared to Examples 1 to 4 according to the present invention.

### Test Example 2

Based on the test results in the test examples for Example 3 of an exemplary embodiment of the present invention, the physical properties in component applications and the dynamics shown in vehicle application of a conventional muffler hanger of non-oil second EPDM 100 phr were compared and analyzed.

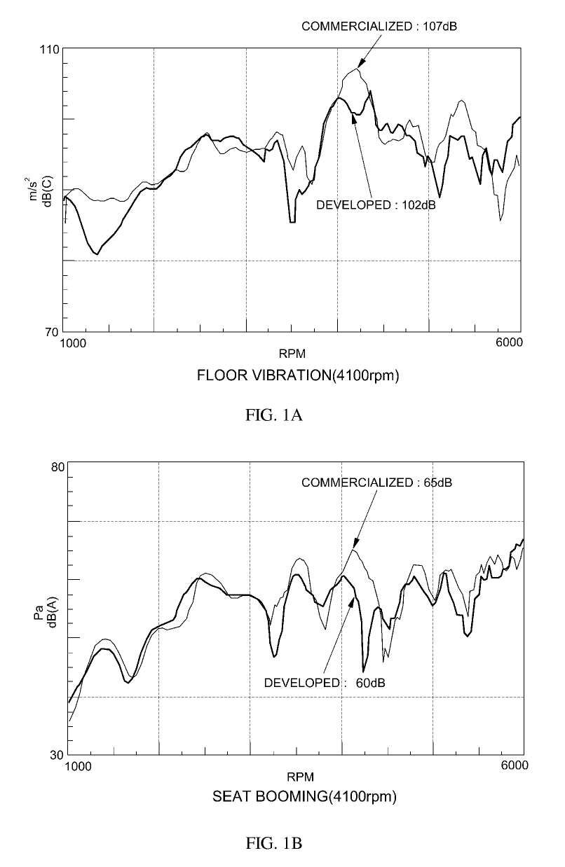

The results thereof are shown in Table 4. The noise measurement results for two products in a floor vibration state and a seat booming state after vehicle application were each compared, and shown in FIG. 1.

TABLE 4

| | | Evaluation Results | | |
|---|---|---|---|---|
| | | Conventional | | |
| | | composition | | |
| | | (Commercial- | Example 3 | |
| Item | | ized) | (Developed) | Note |
| Component | Dynamic Ratio | 4.0 | 2.0 | Improved |
| | (@100 Hz) | | | Twice |
| | Durability | 1,000,000 | 1,000,000 | Equal |
| | (Room | OK | OK | Level |
| | temperature/ | | | |
| | Thermal | | | |
| | Resistance) | | | |
| Vehicle | Vibration/ | 107/65 | 102/60 | 5 dB↓ |
| | Booming | | | |
| | (dB) | | | |

As seen from the test results described above, when a muffler hanger prepared using the composition of Example 3 according to an exemplary embodiment of the invention, physical properties may be substantially improved as compared to the conventional product. Accordingly, the muffler hanger in an exemplary embodiment of the invention may significantly decrease customer complaints.

In addition, the EPDM rubber composition with high thermal resistance and low dynamic ratio according to the present invention may be optimally used in manufacturing a muffler hanger of a vehicle. Particularly, the composition may be used for a muffler hanger of a turbo engine and a GDI engine, in which the temperature of an exhaust system may be elevated by about 10° C. with improved physical properties.

What is claimed is:

1. An ethylene propylene diene monomer (EPDM) rubber composition for a muffler hanger with high thermal resistance and low dynamic ratio, comprising:
a blended mixture of a first EPDM and a second EPDM,
wherein the first EPDM include ethylene in an amount of about 68 to 75% by weight, diene in an amount of about 3 to 10% by weight and oil in an amount of about 40 to 60% by weight based on the total weight of the first EPDM,
wherein the second EPDM includes ethylene in an amount of about 55 to 62% by weight, diene in an amount of about 3 to 10% by weight, and does not contain oil based on the total weight of the second EPDM), and
wherein a weight ratio between the first EPDM and the second EPDM is in a range of about 7:3 to 9:1.

2. The EPDM rubber composition of claim 1, further comprising:
carbon black mixed with Fast Extruding Furnace (FEF) and Medium Thermal (MT) in an amount of about 40 to 60 parts by weight; and
a sulfur cross-linking agent in an amount of about 0.1 to 2.0 parts by weight,
with respect to 100 parts by weight of the pure EPDM rubber substance in the mixture.

3. The EPDM rubber composition of claim 1, further comprising:
a vulcanizing accelerator in an amount of about 1 to 10 parts by weight with respect to 100 parts by weight of the pure EPDM rubber substance in the mixture, wherein the vulcanizing accelerator is one or more selected from sulfonamide-based slow-release accelerators and thiuram-based ultra-accelerators.

4. The EPDM rubber composition of claim 1, further comprising:
one or more aging prevention agents in an amount of about 1 to 10 parts by weight selected from phenyl-based compounds, quinoline-based compounds, and Sunoc with respect to 100 parts by weight of the pure EPDM rubber substance in the mixture.

5. The EPDM rubber composition claim 2, further comprising:
one or more vulcanizing accelerators in 1 to 10 parts by weight selected from tetramethylthiuram disulfide as an ultra-accelerator; and N-cyclohexylbenzothiazole-2-sulfenamide as a slow-release accelerator; and
an aging prevention agent in 1 to 10 parts by weight including one or more selected from N-Phenyl-N′-Isopropyl-P-Pthenylenediamine as a phenyl-based compound, 1,2-dihydro-2,2,4-trimethyl quinoline as a quinoline-based, and Sunoc,
with respect to 100 parts by weight of the pure EPDM rubber substance in the mixture.

6. The EPDM rubber composition of claim 1, further comprising:
one or more activators in an amount of about 1 to 10 parts by weight selected from zinc oxide (ZnO) and polyethylene glycol, with respect to 100 parts by weight of the pure EPDM rubber substance in the mixture.

7. The EPDM rubber composition of claim 1, further comprising stearic acid in an amount of about 1 to 3 parts by weight as a vulcanizing coagent, with respect to 100 parts by weight of the pure EPDM rubber substance in the mixture.

8. The EPDM rubber composition of claim 5, further comprising:
one or more activators in an amount of about 1 to 10 parts by weight selected from zinc oxide (ZnO) and polyethylene glycol; and
stearic acid in an amount of about 1 to 3 parts by weight as a vulcanizing coagent, with respect to 100 parts by weight of the pure EPDM rubber substance in the mixture.

9. The EPDM rubber composition of claim 2, further comprising:
peroxide in an amount of about 1 to 10 parts by weight with respect to 100 parts by weight of the pure EPDM rubber substance in the mixture.

10. The EPDM rubber composition of claim 1, wherein Mooney viscosity (ML₁₊₄) ranges from about 55 to about 65 at a temperature of about 100° C.

11. A muffler hanger of a vehicle manufactured using the EPDM rubber composition of claim 1.

12. A vehicle equipped with the muffler hanger of claim 11.
